(19) United States
(12) Patent Application Publication
(10) Pub. No.: US 2012/0254764 A1
(43) Pub. Date: Oct. 4, 2012

(54) SYSTEM TO SUGGEST AND AUTOMATICALLY ORGANIZE EVENTS FOR SOCIAL ACTIVITIES

(75) Inventors: Kalyan Ayloo, Sunnyvale, CA (US); Supreeth Hosur Nagesh Rao, Santa Clara, CA (US)

(73) Assignee: Yahoo! Inc., Sunnyvale, CA (US)

(21) Appl. No.: 13/078,795

(22) Filed: Apr. 1, 2011

(51) Int. Cl. G06F 3/01

(52) U.S. Cl. 715/738

(57) ABSTRACT

Embodiments are directed towards automatically organizing an event for users to participate in an activity. The system can display suggestions for a plurality of activities to a user. Further, the system may selectively display information about at least one other user with at least one activity of the plurality of activities. The at least one other user may be identified based on the at least one other user having an interest in the at least one activity. Thus, the user may be able to view other users who are interested in an activity and may be nudged to also be interested in the activity. When a minimum number of other users indicate an explicit interest for an activity, the system can automatically organize an event for the users for the activity. The event may be a physical offline gathering of users that are interested in the activity.

### TECHNICAL FIELD

The present invention relates generally to managing network information and, more particularly, but not exclusively to suggesting activities and automatically organizing events for users in social networks.

### BACKGROUND

Tremendous changes have been occurring in the interact that influence our everyday lives. For example, online social networks have become the new meeting grounds. The development of online social networks touch countless aspects of our everyday lives, providing instant access to people of similar mindsets, and enabling us to form partnerships with more people in more ways than ever before. Similarly, online social networks allow users to communicate with more people in a shorter period of time.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client device that may be included in a system such as that shown in FIG. 1;

FIG. 3 shows an embodiment of a network device that may be included in a system such as that shown in FIG. 1;

FIG. 4 illustrates a logical flow diagram generally showing one embodiment of an overview process for suggesting activities and automatically organizing an event for interested users;

FIG. 5 illustrates a logical flow diagram generally showing one embodiment of a process for identifying and displaying suggestions for a plurality of activities;

FIG. 6 illustrates a logical flow diagram generally showing one embodiment of a process for selectively displaying other users interested in an activity;

FIG. 7 illustrates a logical flow diagram generally showing one embodiment of a process for automatically organizing an event;

FIGS. 8A & 8B show non-limiting and non-exhaustive examples of a use case illustrating an interface for receiving a user request for activity suggestions;

FIGS. 9A-9E show non-limiting and non-exhaustive examples of use cases illustrating an interface for displaying activity suggestions to a user and receiving an interest input from the user; and

FIG. 10 illustrates a logical flow diagram generally showing one alternative embodiment of an overview process for suggesting activities and automatically organizing an event for interested users.

### DETAILED DESCRIPTION

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or.” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “social network” refers to a concept that an individual's personal network of friends, family colleagues, coworkers, and the subsequent connections within those networks, can be utilized to find more relevant connections for a variety of activities, including, but not limited to dating, job networking, service referrals, content sharing, like-minded individuals, activity partners, or the like.

An online social network typically comprises a person's set of direct and/or indirect personal relationships, including real and virtual privileges and permissions that users may associate with these people. Direct personal relationships usually include relationships with people the user can communicated with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship.

As used herein, the term “member” refers to a user who is included in a social network.

As used herein, the term “activity” refers to any action performed by a physical gathering of people at a certain place during a time for a purpose. An activity may include offline activities, such as attending concerts, playing sports, dining at restaurants, or the like. Activity may also include actions performed online by a gathering of people, such as playing an online video game, talking in a chat room, or the like.

As used herein, the term “event” refers to a gathering of multiple people to attend, partake, contribute, join, share, or otherwise participate in an activity.

As used herein, the term “sponsor” refers to any entity, individual, partnership, company, business, or the like, that may buy, rent, lease, bid, and/or otherwise provide value for an activity to be suggested to user.

As used herein, the phrase “user actions” refers to any online behavior performed by a user. User actions may include, but are not limited to, user searches, user behavior on social networking sites, click through behavior on web pages, user generated content, social bookmarking, user viewing history, user shopping behavior, messenger and email actions and content, or the like.

As used herein, the term “attribute” refers to any user actions and/or demographic information about a user.

As used herein, the term “nudge” refers to an action that prompts, encourages, provokes, and/or otherwise induces a user to become interested in and/or participate in an activity.

As used herein, the term “explicit interest” refers to any indication of a user's excitement for an activity, resulting from a user's direct action.

As used herein, the term “implicit interest” refers to any implied user excitement for an activity based on the user's actions and/or behaviors.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, the present invention is directed towards methods and systems for automatically organizing an event for a plurality of users to participate in a suggested activity. On any given day, a user may want to participate in an activity, but not if the user participates alone. If, however, the user is provided information that other users, such as friends of the user, are also interested in an activity, then the user may be nudged to participate in the activity. Based on the interest in an activity of the user and other users, the system can automatically organize an event for the user and the interested other users.

The system can display suggestions for a plurality of activities to a first user. Further, the system may selectively display to the first user, information about at least one other user with at least one activity of the plurality of activities. The at least one other user may be identified based on the at least one other user having an interest in the at least one activity. As a result, the first user may be able to view suggested activities, as well as information about other users who are interested in the suggested activities. Since the first user may be able to view information about other users who are interested in an activity, the first user may be nudged to also be interested in the activity.

In some embodiments, the system may selectively display information about other users who have indicated an explicit interest in the at least one activity, such as other users who have actively clicked on an icon to indicate that they are interested in an activity. In other embodiments, the system may selectively display information about other users that have an implicit interest in the at least one activity, such as implied interests that are based on online behaviors of the other users.

The system can further nudge users to participate in an activity by modifying the selective display of a user having an implicit interest to signify that the user has indicated an explicit interest. The modification of the selective display can result in progressive nudging, which is described in more detail below. For Example, assume a second user has an implicit interest in boating. A first user may see the suggested activity of boating and that the second user “may be interested.” If the second user indicates an explicit interest, such as by clicking on an “I am very interested” button, then the first user's display may change to show that the second user is very interested in boating. The change of the first user's display may further nudge the first user to indicate an explicit interest in the activity, which in turn may nudge a third user, and so on.

When a minimum number of other users indicate an explicit interest for an activity, the system can automatically organize an event for the first user and the other users. For example, when the minimum number of people have an explicit interest in boating, the system can automatically organize an event for at least the minimum number of people to go boating. In some embodiments, the event may be a physical offline gathering of users that are interested in the activity. In other embodiments, the event may be an online gathering. When the minimum number of users have indicated an explicit interest, then the system can automatically organize the event, including sending invites for an activity, determining a time and place, determining and/or automatically reserving a venue, renting equipment for the event, or the like.

### Illustrative Operating Environment

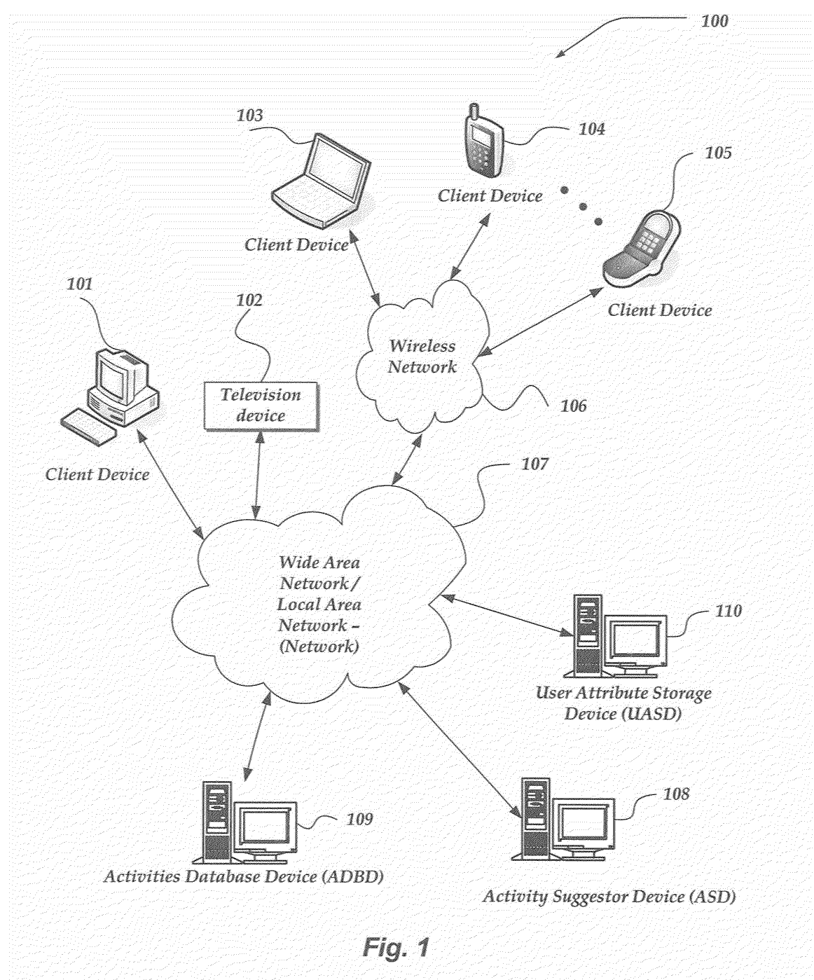

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 107, wireless network 106, client devices 101-105, Activity Suggestor Device (“ASD”) 108, Activities Database Device (“ADBD”) 109, User Attribute Storage Device (“UASD”) 110.

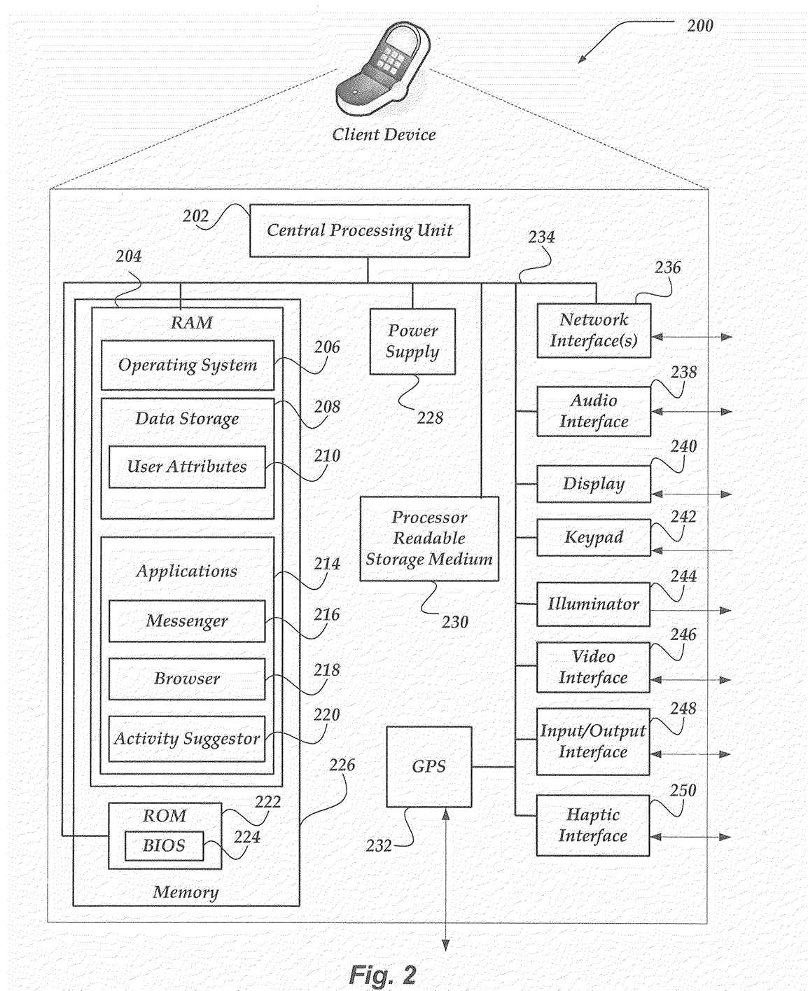

One embodiment of client devices 101-105 is described in more detail below in conjunction with FIG. 2. Generally, however, client devices 103-105 may include virtually any portable computing device capable of receiving and sending a message over a network, such as network 107, wireless network 106, or the like. Client devices 103-105 may also be described generally as client devices that are configured to be portable. Thus, client devices 103-105 may include virtually any portable computing device capable of connecting to another computing device and receiving information. Such devices include portable devices, such as cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. As such, client devices 103-105 typically range widely in terms of capabilities and features. In one non-limiting example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Client device 101 may include virtually any computing device capable of communicating over a network to send and receive information, including activity suggestion information, performing various online activities, or the like. The set of such devices may include devices that typically connect using a wired or wireless communications medium such as personal computers, multiprocessor systems, microprocessor-based or programmable consumer electronics, network PCs, or the like. In one embodiment, at least some of client devices 101-105 may operate over wired and/or wireless network. Client device 102 may include virtually any device useable as a television device. Today, many of these devices include a capability to access and/or otherwise communicate over a network such as network 107 and/or even wireless network 106. Moreover, client device 102 may access various computing applications, including a browser, or other web-based application.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the client device may employ the browser application to perform various actions and/or activities over a network (online), such as view suggestions for a plurality of activities with other users having an interest in at least one of the plurality of activities and enabling a user to provide indications of a explicit interest for an activity. However, another application may also be used to perform various online actions and/or activities.

Client devices 101-105 may further be configured to include a client application that enables an end-user to log into an end-user account that may be managed by another computing device, such as ASD 108, ADBD 109, UASD 110, or the like. Such end-user account, in one non-limiting example, may be configured to enable the end-user to manage one or more online activities, including in one non-limiting example, search activities, social networking activities, browse various web sites, make purchases, sell products/services, communicate with other users, or share attachments with others, or the like. However, participation in such online networking activities may also be performed without logging into the end-user account.

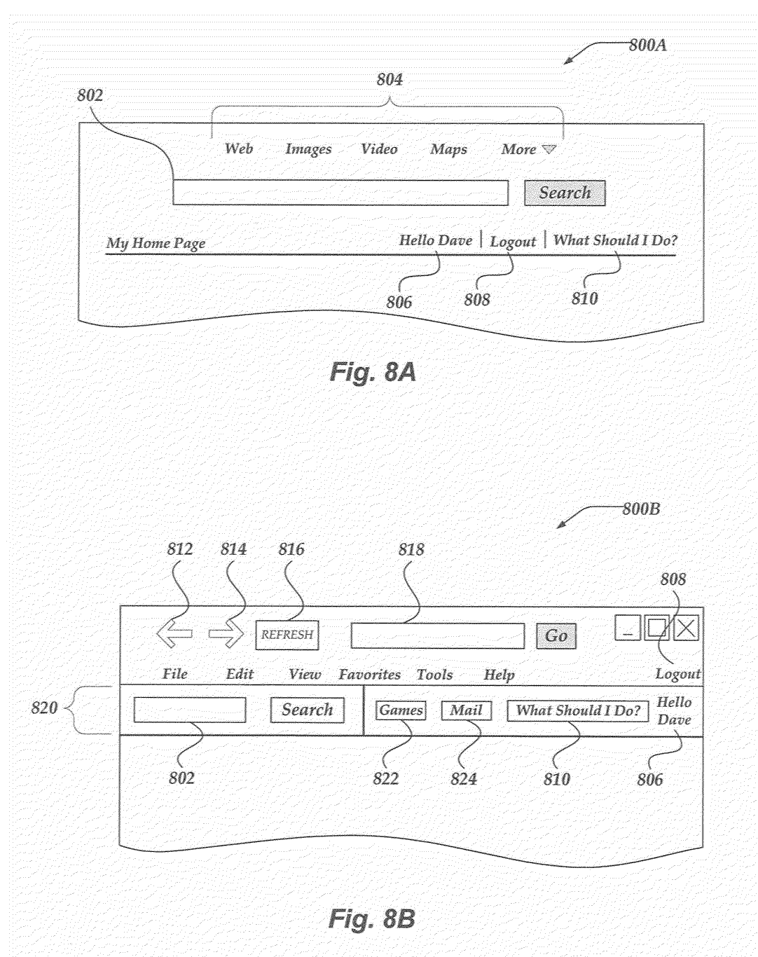

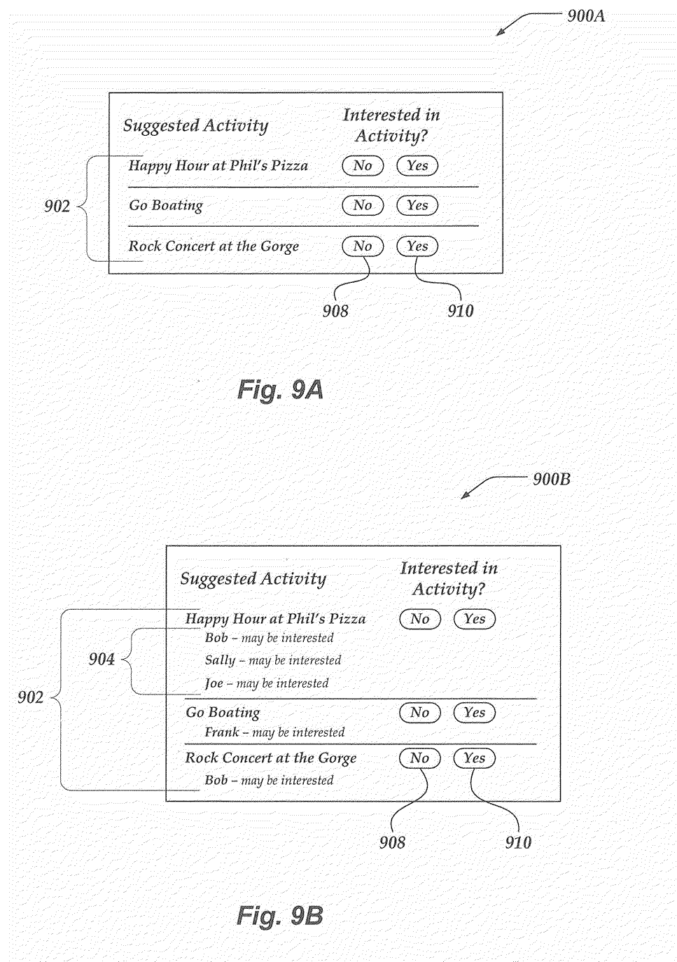

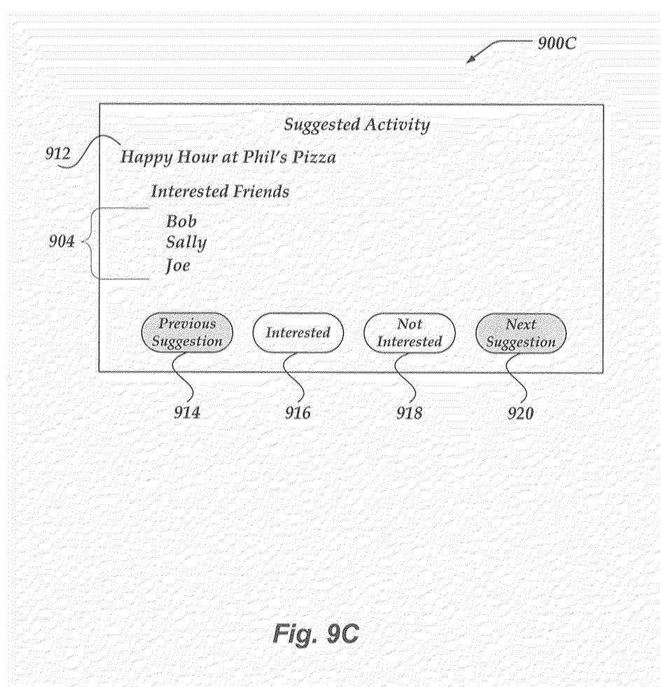

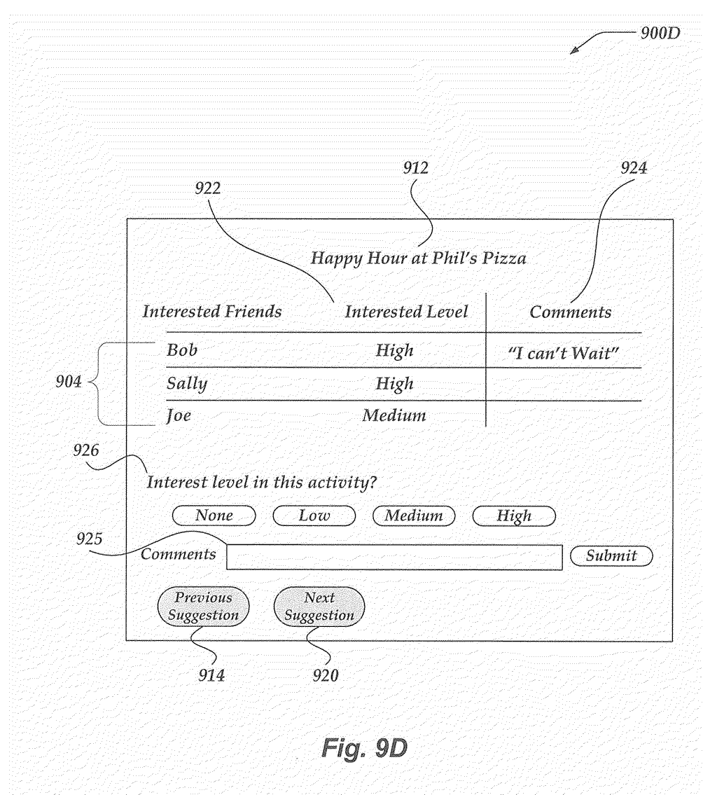

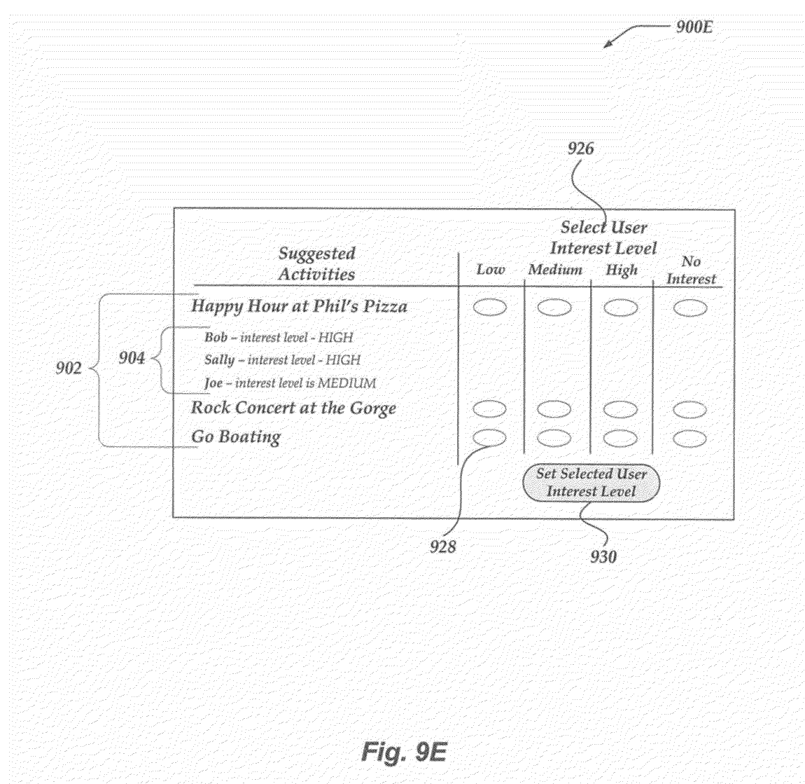

In addition, client devices 101-105 also may include another application that is configured to enable a user of client devices 101-105 to receive for display suggested activities and information about at least one other users having an interest in at least one of the suggested activities. In one embodiment, the application may be configured to enable the user to provide an indication of an explicit interest in at least one of the suggested activities. In one embodiment, the application may be downloaded onto a client device, for example over networks 106 and 107 from ASD 108, or the like. In another embodiment, client devices 101-105 may employ a browser interface to access a web site, applet, script, or the like that enables a user to view and interact with suggested activities. In one embodiment, a user may view a plurality of activity suggestions with at least one other user having an interest in at least one of the plurality of activity suggestions. In some embodiments, a user may indicate an explicit interest in a suggested activity. Non-limiting examples of user interfaces to allow a current user to initiate activity suggestions are described in more detail below in conjunction with FIGS. 8A and 8B. Additionally, non-limiting examples of a user interface for displaying activity suggestions to a user and receiving an interest input from the user are described in more detail below in conjunction with FIGS. 9A-9E.

The client application may further provide information that identifies itself, including a type, capability, name, or the like. In one embodiment, client devices 101-105 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a network packet, or the like, sent between other client devices, ASD 108, ADBD 109, UASD 110, or other computing devices.

Wireless network 106 is configured to couple client devices 103-105 and its components with network 107. Wireless network 106 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, or the like. In one embodiment, the system may include more than one wireless network.

Wireless network 106 may further include an autonomous system of terminals gateways, routers, and the like connected by wireless radio links, and the like. These connectors may be configured to move freely and randomly and organize themselves arbitrarily, such that the topology of wireless network 106 may change rapidly.

Wireless network 106 may further employ a plurality of access technologies including 2nd (2G), 3rd (3G), 4th (4G) generation radio access for cellular systems, WLAN, Wireless Router (WR) mesh, and the like. Access technologies such as 2G, 3G, 4G and future access networks may enable wide area coverage for mobile devices, such as client devices 103-105 with various degrees of mobility. In one non-limiting example, wireless network 106 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 106 may include virtually any wireless communication mechanism by which information may travel between client devices 103-105 and another computing device, network, and the like.

Network 107 is configured to couple network devices with other computing devices, including, ASD 108, ADBD 109, UASD 110, client devices 101 and 102, and through wireless network 106 to client devices 103-105. Network 107 is enabled to employ any form of computer readable media for communicating information from one electronic device to another. Also, network 107 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In one embodiment, network 107 may be configured to transport information of an Internet Protocol (IP). In essence, network 107 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

Activities Database (ADBD) 109 includes virtually any network device usable to operate as web site servers to obtain and/or store activity information. Moreover, ADBD 109 may also operate as a File Transfer Protocol (FTP) server, a database server, activity download server, or the like. Additionally, ADBD 109 may be configured to perform multiple functions. In one embodiment, ADBD 109 may provide a platform for sponsors to bid on activity suggestions. Thus, ADBD 109 may store information about sponsor paid activity suggestions. Similarly, ADBD 109 may provide a platform for editors to select activities and upload information for the selected activities. In yet another embodiment, ADBD 109 may provide a platform for users to publish activities. In one embodiment, ADBD 109 may mine user actions from client devices 101-105 to obtain information about activities. ADBD 109 may be configured to send activity information to ASD 108 and/or provide ASD 108 access to activity information. In some embodiments, ADBD 109 may obtain and/or store information about offline physical activities and/or online activities.

Although FIG. 1 illustrates ADBD 109 as a single computing device, the invention is not so limited. For example, one or more functions of the ADBD 109 may be distributed across one or more distinct network devices. Further, while ADBD 109 illustrates a network device useable to obtain and/or store activities, the invention is not so limited. Thus, in one embodiment, one or more functions of ASD 108 and/or UASD 110 may also be performed by ADBD 109.

Moreover, ADBD 109 is not limited to a particular configuration. Thus, in one embodiment, ADBD 109 may contain a plurality of network devices to obtain and/or store activities. Similarly, in another embodiment, ADBD 109 may contain a plurality of network devices that operate using a master/slave approach, where one of the plurality of network devices of ADBD 109 operates to manage and/or otherwise coordinate operations of the other network devices. In other embodiments, the ADBD 109 may operate as a plurality of network devices within a cluster architecture, a peer-to-peer architecture, and/or even within a cloud architecture. Thus, the invention is not to be construed as being limited to a single environment, and other configurations, and architectures are also envisaged.

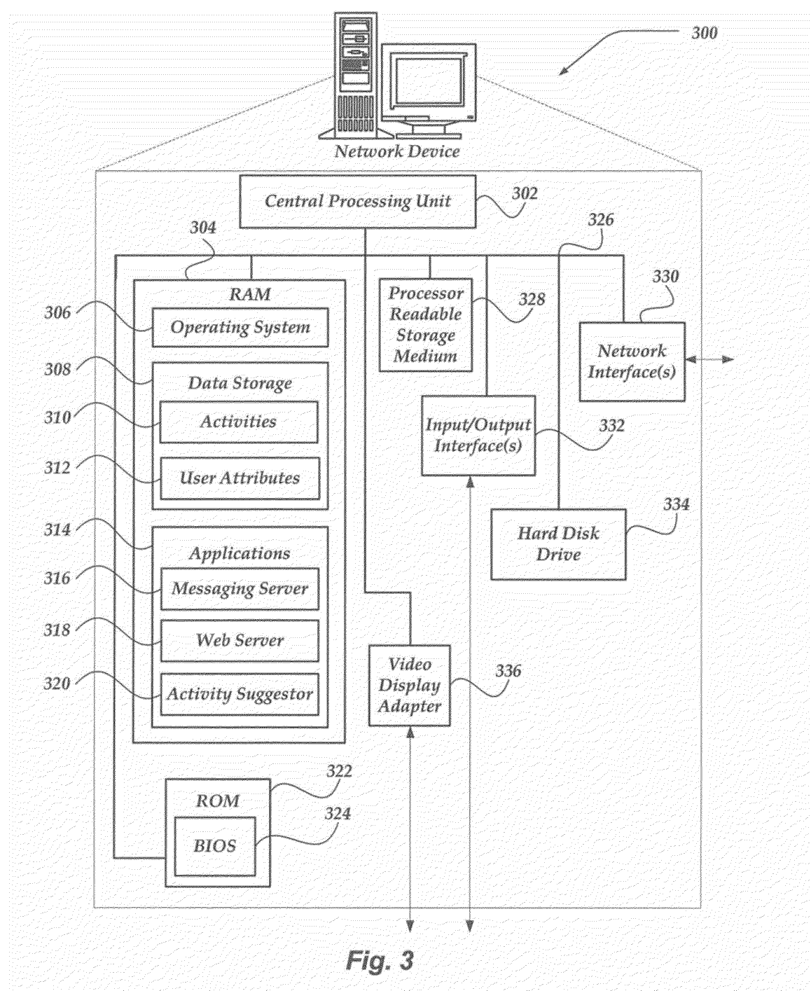

One embodiment of ASD 108 is described in more detail below in conjunction with FIG. 3. Briefly, however, ASD 108 may include any computing device capable of connecting to network 107 to identify suggestions for a plurality of activities, provide the plurality of activities to client devices 101-105 for a user, and automatically organize an event. ASD 108 may be configured to receive activity information from ADBD 109. Similarly, ASD 108 may be configured to receive user attributes from UASD 110. ASD 108 may be configured to identify suggestions for a plurality of activities based on activity information. In one embodiment, ASD 108 may identify activities that a user may have an implicit interest in, based on user attributes received from UASD 110. In another embodiment, ASD may prioritize the plurality of activities based on user attributes.

ASD 108 may also identify other users having an interest in at least one activity of a plurality of activities. Further, ASD 108 may provide the information about the identified other users to client devices 101-105 to be selectively displayed with the respective at least one activity. Moreover, ASD 108 may also be configured to receive indications of explicit interest of users from client devices 101-105. In some embodiments, ASD 108 may modify the selective display of at least one user having an implicit interest to signify that the at least one user has indicated an explicit interest.

Additionally, ASD 108 may be configured to automatically organize an event for a plurality of users of client devices 101-105. In one embodiment, ASD 108 may automatically organize an event based on a minimum number of other users indicating an explicit interest above a threshold for an activity in the plurality of activities. In one embodiment, the event is an offline physical gathering of users. Additionally, in one embodiment, ASD 108 may automatically initiate a communication to users of client devices 101-105 to provide information about an automatically organized event. A non-limiting example of such a communication may include emails, instant messages, calendar updates, or the like. Similarly, ASD 108 may determine a location, time, and/or resources for the automatically organized event.

Although FIG. 1 illustrates ASD 108 as a single computing device, the invention is not so limited. For example, one or more functions of the ASD 108 may be distributed across one or more distinct network devices. Further, while ASD 108 illustrates a network device useable to automatically organize an event, the invention is not so limited. Thus, in one embodiment, one or more functions of ADBD 109 and/or UASD 110 may also be performed by ASD 108.

Moreover, ASD 108 is not limited to a particular configuration. Thus, in one embodiment, ASD 108 may contain a plurality of network devices to identify a plurality of activity suggestions and automatically organize an event. Similarly, in another embodiment, ASD 108 may contain a plurality of network devices that operate using a master/slave approach, where one of the plurality of network devices of ASD 108 operates to manage and/or otherwise coordinate operations of the other network devices. In other embodiments, the ASD 108 may operate as a plurality of network devices within a cluster architecture, a peer-to-peer architecture, and/or even within a cloud architecture. Thus, the invention is not to be construed as being limited to a single environment, and other configurations, and architectures are also envisaged.

UASD 110 includes virtually any network device usable to operate as web site servers to obtain and/or store activity information. Moreover, UASD 110 may also operate as a File Transfer Protocol (FTP) server, a database server, activity download server, or the like. Additionally, UASD 110 may be configured to perform multiple functions. In one embodiment, UASD 110 may be configured to obtain and/or store user attributes. User attributes may include, but are not limited online behavior, demographic information, or the like. UASD 110 may obtain user online behavior of users from client devices 101-105. Similarly, UASD 110 may obtain demographic information about client devices 101-105 and/or about users of client devices 101-105. In one embodiment, UASD 110 may be configured to provide user attributes to ASD 108. In another embodiment, UASD 110 may be configured to provide ASD 108 access to user attributes.

Although FIG. 1 illustrates UASD 110 as a single computing device, the invention is not so limited. For example, one or more functions of the UASD 110 may be distributed across one or more distinct network devices. Further, while UASD 110 illustrates a network device useable to determine user attributes, the invention is not so limited. Thus, in one embodiment, one or more functions of ADBD 109 and/or ASD 108 may also be performed by UASD 110.

Moreover, UASD 110 is not limited to a particular configuration. Thus, in one embodiment, UASD 110 may contain a plurality of network devices to determine user attributes. Similarly, in another embodiment, UASD 110 may contain a plurality of network devices that operate using a master/slave approach, where one of the plurality of network devices of UASD 110 operates to manage and/or otherwise coordinate operations of the other network devices. In other embodiments, the UASD 110 may operate as a plurality of network devices within a cluster architecture, a peer-to-peer architecture, and/or even within a cloud architecture. Thus, the invention is not to be construed as being limited to a single environment, and other configurations, and architectures are also envisaged.

Devices that may operate as ASD 108, ADBD 109, and/or, UASD 110 include various network devices, including, but not limited to personal computers, desktop computers, multiprocessor systems, microprocessor-based or programmable consumer electronics, network PCs, server devices, network appliances, and the like.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-105 of FIG. 1.

As shown in the figure, client device 200 includes a processing unit (CPU) 202 in communication with a mass memory 226 via a bus 234. Client device 200 also includes a power supply 228, one or more network interfaces 236, an audio interface 238, a display 240, a keypad 242, an illuminator 244, a video interface 246, an input/output interface 248, a haptic interface 250, and an optional global positioning systems (GPS) receiver 232. Power supply 228 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 236 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide interoperability for Microwave Access (WiMax), SIP/RTP, or any of a variety of other wireless communication protocols. Network interface 236 is sometimes known as a transceiver, transceiving device, or network interface card (NIC).

Audio interface 238 is arranged to produce and receive audio signal s such as the sound of a human voice. For example, audio interface 238 may be coupled to a speaker and microphone (not shown) to enable telecommunication with others and/or generate an audio acknowledgement for some action. Display 240 may be a liquid crystal display (LCD), gas plasma, light emitting diode (LED), or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images. Illuminator 244 may provide a status indication and/or provide light. Illuminator 244 may remain active for specific periods of time or in response to actions. For example, when illuminator 244 is active, it may backlight the buttons on keypad 242 and stay on while the client device is powered. Also, illuminator 244 may backlight these buttons in various patterns when particular actions are performed, such as dialing another client device. Illuminator 244 may also cause light sources positioned within a transparent or translucent case of the client device to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client device 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like. Haptic interface 250 is arranged to provide tactile feedback to a user of the client device. For example, the haptic interface 250 may be employed to vibrate client device 200 in a particular way when another user of a computing device is calling.

Optional GPS transceiver 232 can determine the physical coordinates of client device 200 on the surface of the Earth, which typically outputs a location as latitude and longitude values. GPS transceiver 232 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 232 can determine a physical location within millimeters for client device 200; and in other cases, the determined physical location may be less precise, such as within a meter or significantly greater distances. In one embodiment, however, mobile device 200 may through other components, provide other information that may be employed to determine a physical location of the device, including for example, a MAC address, IP address, or the like. Mass memory 226 includes a RAM 204, a ROM 222, and other storage means. Mass memory 226 illustrates an example of computer readable storage media (devices) for storage of information such as computer readable instructions, data structures, program modules or other data. Mass memory 226 stores a basic input/output system (“BIOS”) 224 for controlling low-level operation of client device 200. The mass memory also stores an operating system 206 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Mass memory 226 further includes one or more data storage 208, which can be utilized by client device 200 to store, among other things, applications 214 and/or other data. For example, data storage 208 may also be employed to store information that describes various capabilities of client device 200. The information may then be provided to another device based on any of a variety of actions, including being sent as part of a header during a communication, sent upon request, or the like. Data storage 208 may also be employed to store social networking information including address books, buddy lists, aliases, user profile information, or the like. Further, data storage 208 may also store messages, web page content, or any of a variety of other online information. At least a portion of the information may also be stored on a disk drive or other computer-readable storage device (not shown) within client device 200.

Data storage 208 may further store user attributes 210. User attributes 210 may include a plurality of attributes obtained from a user of client device 200. Additionally, user attributes 210 may include user actions and/or demographic information.

Applications 214 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VoIP applications, contact managers, task managers, transcoders, database programs, word processing programs, security applications, spreadsheet programs, games, search programs, and so forth. Applications 214 may include, for example, messenger 216, browser 218, and activity suggestor 220.

Browser 218 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. However, any of a variety of other web-based languages may be employed. In one embodiment, browser 218 may enable a user of client device 200 to view suggestions for a plurality of activities with other users having an interest in at least one of the plurality of activities. Further, browser 218 may enable a user of client device 200 to provide indications of an explicit interest for an activity. Moreover, browser 218 may enable tracking, monitoring, and/or storing of user attributes, such as user actions and/or user demographic information by UASD 110 of FIG. 1. Additionally, browser 218 may enable a user of client device 200 to receive automatically initiated communications from ASD 108 when an event is automatically organized.

Messenger 216 may be configured to manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, messenger 216 may be configured as an IM application, such as AOL Instant Messenger, Yahoo! Messenger, .NET Messenger Server, ICQ, or the like. In one embodiment, messenger 216 may be configured to include a mail user agent (MUA) such as Elm, Pine, MH, Outlook, Eudora, Mac Mail, Mozilla Thunderbird, or the like. In another embodiment, messenger 216 may be a client application that is configured to integrate and employ a variety of messaging protocols, including, but not limited to various push and/or pull mechanisms for client device 200. In one embodiment, messenger 216 may interact with browser 218 for managing messages. As used herein, the term “message” refers to any of a variety of messaging formats, or communications forms, including but not limited to email, SMS, IM, MMS, IRC, or the like.

In one embodiment, messaging server 216 may be configured to receive messages sent from network devices, such as ASD 108 of FIG. 1. In other embodiments, messaging server 216 may be configured to track and/or monitor message transfers and store as user attributes 210.

Activity suggestor 220 may be configured to employ a process to identify suggestions for a plurality of activities and display the plurality of activities using display 240 for a user. In one embodiment, activity suggestor 220 may identify suggestions for a plurality of activities that a user of client device 200 may have an implicit interest in based on user attributes 210 and/or user attributes obtained from a server, such as UASD 110 of FIG. 1. Additionally, activity suggestor 220 may obtain the plurality of activities from a server, such as ADHD 109 of FIG. 1.

Moreover, activity suggestor 220 may also identify and selectively display other users having an interest in at least one activity of the plurality of activities based on other user attributes received from a server, such as UASD 110 of FIG. 1. In some embodiments, activity suggestor 220 may modify the selective display of at least one user having an implicit interest to signify that the at least one user has indicated an explicit interest.

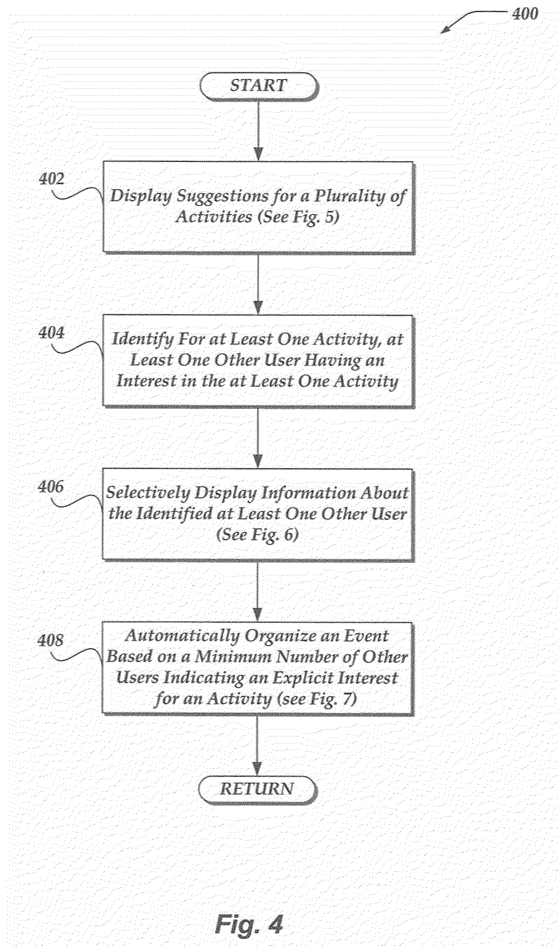

In some embodiments, activity suggestor 220 may be configured to automatically organize an event for a plurality of users. In one embodiment, activity suggestor 220 may automatically organize an event based on a minimum number of other users above a threshold indicating an explicit interest for an activity in the plurality of activities. Additionally, in one embodiment, activity suggestor 220 may automatically initiate a communication to users of client devices 101-105 of FIG. 1 to provide information about an automatically organized event. Similarly, activity suggestor 220 may determine a location and time for the automatically organized event. In other embodiments, activity suggestor 220 may enable a server, such as ASD 108 of FIG. 1, to automatically organize an event. In one embodiment, when a minimum number of other users above a threshold indicate an explicit interest for an activity, activity suggestor 220 may provide ASD 108 of FIG. 1 with information about the user of client device 200 and the other users. Thus, ASD 108 of FIG. 1 may automatically organize an event for the activity. In another embodiment, a user indicating an explicit interest, for example, may also enter a request for the system to organize the event. In any event, activity suggestor 220 in conjunction with ADBD 109 of FIG. 1, ASD 108 of FIG. 1, and UASD 110 of FIG. 1 may employ processes similar to those described below in conjunction with FIGS. 4-8 to perform at least some of its actions.

illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may be configured to operate as a server, client, peer, or any other device. Network device 300 may represent, for example ASD 108, ADBD 109, UASD 110 of FIG. 1, or a combination of ASD 108, ADBD 109, and UASD 110.

Network device 300 includes processing unit 302, video display adapter 336, input/output interface 332, and a mass memory, all in communication with each other via bus 326. The mass memory generally includes RAM 304, ROM 322 and one or more permanent mass storage devices, such as hard disk drive 334, tape drive, optical drive, and/or floppy disk drive. The mass memory stores operating system 306 for controlling the operation of network device 300. Any general-purpose operating system may be employed. Basic input/output system (“BIOS”) 324 is also provided for controlling the low-level operation of network device 300. As illustrated in FIG. 3, network device 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network device 300 also comprises input/output interface 332 for communicating with external devices, such as a headset, or other input or output devices not shown in FIG. 3. Input/output interface 332 can utilize one or more communication technologies, such as USB, infrared, Bluetooth™, or the like.

The mass memory as described above illustrates another type of computer-readable media, namely computer-readable storage media and/or processor-readable storage medium. Computer-readable storage media (devices) may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

As shown, data storage 308 may include a database, text, spreadsheet, folder, file, or the like, that may be configured to maintain and store user account identifiers, user profiles, email addresses, IM addresses, and/or other network addresses; or the like. Data stores 308 may further include program code, data, algorithms, and the like, for use by a processor, such as central processing unit (CPU) 302 to execute and perform actions. In one embodiment, at least some of data store 308 might also be stored on another component of network device 300, including, but not limited to processor-readable storage medium 328, hard disk drive 334, or the like. Data storage 308 may further store activities 310 and/or user attributes 312.

Activities 310 may include information about sponsor paid activities, editor selected activities, user published activities, mined activities based on user actions, or the like. Activities 310 may include information about offline physical activities and/or online activities.

User attributes 312 may include a plurality of attributes obtained from a user of a client device, such as client device 200 of FIG. 2. Additionally, user attributes 210 may include user actions and/or demographic information.

The mass memory also stores program code and data. One or more applications 314 are loaded into mass memory and run on operating system 306. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Messaging server 316, web server 318, and activity suggestor 320 may also be included as application programs within applications 314.

Messaging server 316 may include virtually any computing component or components configured and arranged to forward messages from message user agents, and/or other message servers, or to deliver messages to a local message store, such as data storage 308, or the like. Thus, messaging server 316 may include a message transfer manager to communicate a message employing any of a variety of email protocols, including, but not limited, to Simple Mail Transfer. Protocol (SMTP), Post Office Protocol (POP), Internet Message Access Protocol (IMAP), NNTP, or the like. Messaging server 316 may also be managed by one or more components of messaging server 316. Thus, messaging server 316 may also be configured to manage SMS messages, IM, MMS, RSS feeds, mIRC, or any of a variety of other message types. In one embodiment, messaging server 316 may enable users to initiate and/or otherwise conduct chat sessions, VoIP sessions, or the like.

In one embodiment, messaging server 316 may be configured to automatically send a communication to users, such as users of client devices 101-105 of FIG. 1, to provide the users with information about an automatically organized event. In other embodiments, messaging server 316 may be configured to track and/or monitor message transfers and store as user attributes 312.

Web server 318 represent any of a variety of services that are configured to provide content, including messages, over a network to another computing device. Thus, web server 318 includes, for example, a web server, a File Transfer Protocol (FTP) server, a database server, a content server, or the like. Web server 318 may provide the content including messages over the network using any of a variety of formats including, but not limited to WAP, HDML, WML, SMGL, HTML, XML, cHTML, xHTML, or the like. In one embodiment, web server 318 may be configured to track and/or monitor, user actions and store as user attributes 312. Additionally, web server 318 may be configured to provide a platform for sponsors to hid on activity suggestions, editors to select and upload activity suggestions, users to upload and publish activities. In another embodiment, web server may track user actions to determine mined activities.

Activity suggestor 320 may be configured to employ a process to identify suggestions for a plurality of activities, provide the plurality of activities to a client device, such as client device 200 of FIG. 2 for a user, and automatically organize an event. Activity suggestor 320 may identify suggestions for a plurality of activities from activities 310. In one embodiment, activity suggestor 320 may identify activities that a user may have an implicit interest in, based on user attributes 312. Activity suggestor 320 may also identify and provide to a client device, such as client device 200 of FIG. 2, for selectively displaying, other users having an interest in at least one activity of the plurality of activities. In some embodiments, activity suggestor 320 may provide a modified selective display of at least one user having an implicit interest to signify that the at least one user has indicated an explicit interest.

Moreover, activity suggestor 320 may be configured to automatically organize an event for a plurality of users, such as users of client devices 101-105 of FIG. 1. In one embodiment, activity suggestor 320 may automatically organize an event based on a minimum number of other users indicating an explicit interest above a threshold for an activity in the plurality of activities. Additionally, in one embodiment, activity suggestor 320 may automatically initiate a communication to users of client devices 101-105 of FIG. 1 to provide information about an automatically organized event. Similarly, activity suggestor 320 may determine a location and time for the automatically organized event. In any event, activity suggestor 320 may employ processes similar to those described below in conjunction with FIGS. 4-8 to perform at least some of its actions.

### General Operation

The operation of certain aspects of the invention will now be described with respect to FIGS. 4-8. FIG. 4 illustrates a logical flow diagram generally showing one embodiment of an overview process for suggesting activities and automatically organizing an event for interested users. In some embodiments, process 400 of FIG. 4 may be implemented by and/or executed on a single network device, such as network device 300 of FIG. 3. In other embodiments, process 400 or portions of process 400 of FIG. 4 may be implemented by and/or executed on a plurality of network devices, such as network device 300 of FIG. 3.

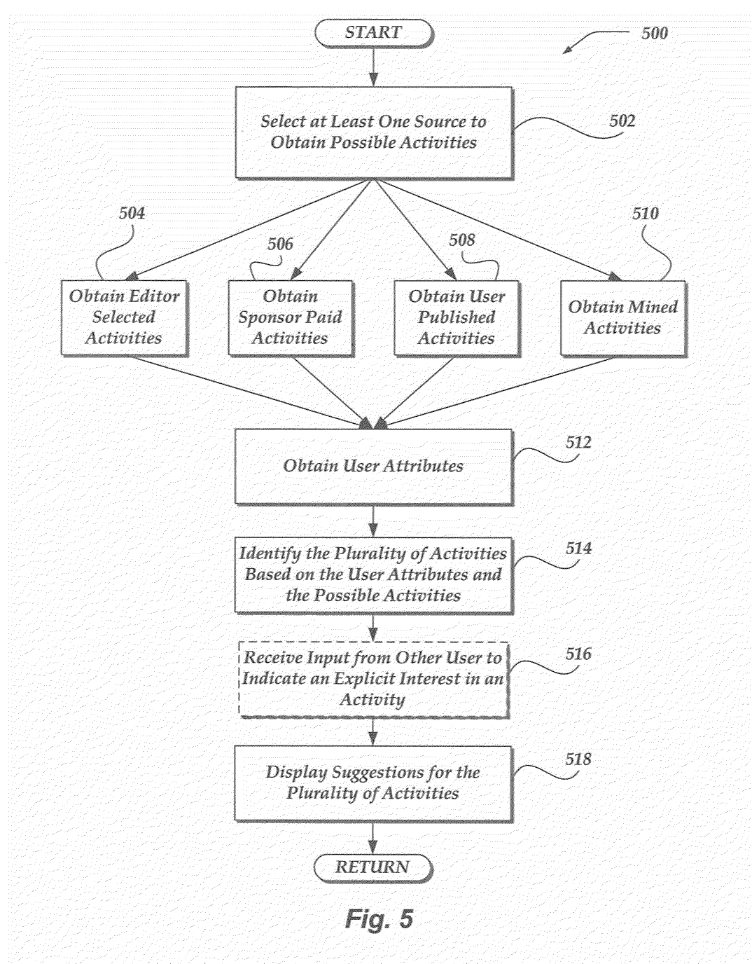

Process 400 begins, after a start block, at block 402, which is described in more detail below in conjunction with FIG. 5. Briefly, however, at block 402 suggestions for a plurality of activities are displayed for a first user. Process 400 then proceeds to block 404, where at least one other user having an interest in at least one activity in the plurality of activities is identified. In some embodiments, process 500 of FIG. 5 may be reproduced for each of the at least one other user. In one embodiment, the at least one other user and the first user may be members of a social network. Thus, in some embodiments, the first user and the at least one other user may have a direct personal relationship, such as a first-degree relationship. In other embodiments, the first user and the at least one other user may have an indirect personal relationship, such as a second-degree or third-degree relationship, such as members in a common social network, club, or the like. In one embodiment, the relationship with other uses may be selectable by the first user.

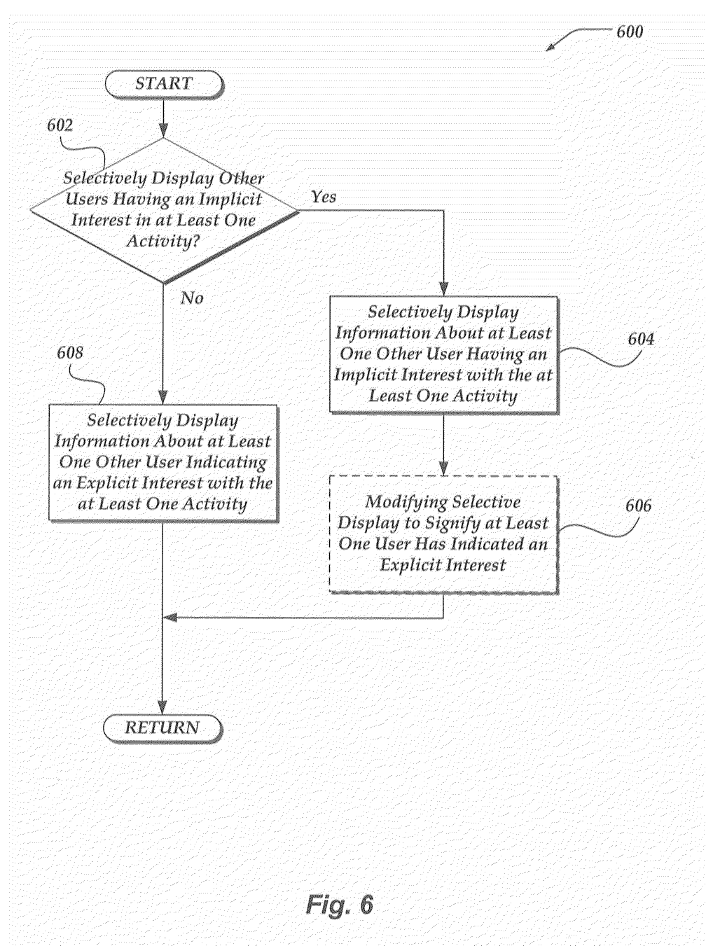

Process 400 next proceeds to block 406, which is described in more detail below in conjunction with FIG. 6. Briefly, however, at block 406 the identified at least one other user is selectively displayed to the first user. FIGS. 9A-9E described below show non-limiting and non-exhaustive examples of use cases illustrating an interface for displaying the suggestions for a plurality of activities and the identified at least one other user with at least one activity.

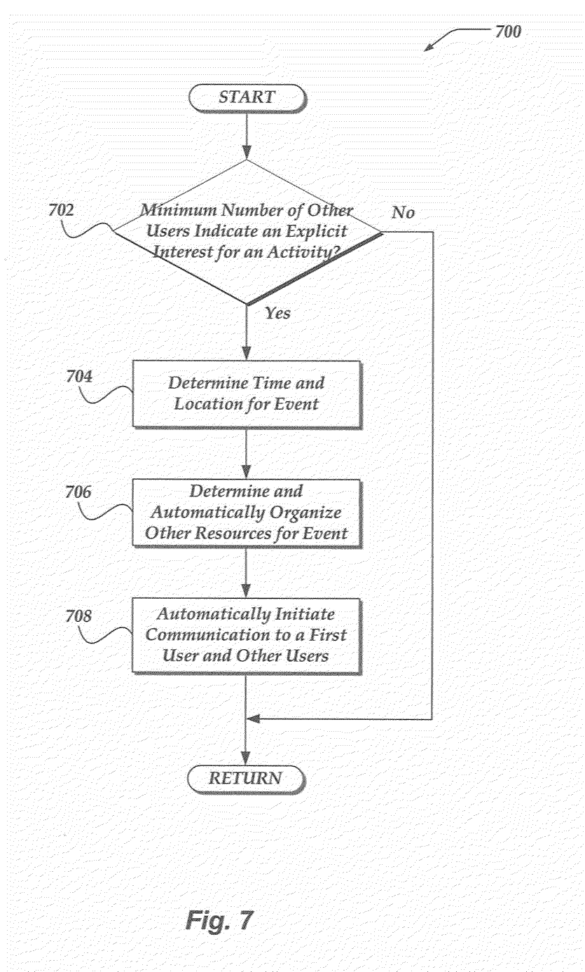

Process 400 continues to block 408, which is described in more detail below in conjunction with FIG. 7. Briefly, however, an event for a first user and other users is automatically organized based on a minimum number of the other users indicating an explicit interest for an activity. After block 408, process 400 returns to a calling process to perform other actions.

In some embodiments, process 400 may be initiated by a user, such as a first user, inputting, a request for activity suggestions. In one embodiment, a user may click on a link to get activity suggestions for “what to do now.” FIGS. 8A and 8B described below show non-limiting and non-exhaustive example of use cases illustrating an interface for receiving a user request for activity suggestions.

FIG. 5 illustrates a logical flow diagram generally showing one embodiment of a process for identifying and displaying suggestions for a plurality of activities to a user. Process 500 of FIG. 5 begins, after a start block, at block 502, where at least one source is selected to obtain possible activities. The selection of at least one source may be made from block 504, block 506, block 508, and/or block 510. Block 504, block 506, block 508, and block 510 may be performed independent of each other or in any combination thereof.

At block 504, editor selected activities are obtained. In some embodiments, an editor may be provided a list of activities. In one embodiment, the editor may receive activities from a social network, where members of the social network provide information about activities. In this embodiment, the members may post, email, and/or otherwise provide activity information to the editor. In another embodiment, the list of activities may be provided by a news organization, such as a newspaper. In yet other embodiments, the list of activities may be obtained from the internet, such as by using a search engine.

After an editor has a list of activities, the editor may select which activities to provide as possible activities. In some embodiments, the editor may select the possible activities based on a location. In one embodiment, the location may be a location of a user, such as a first user. In another embodiment, the location may be a predefined area. For example, one editor may select activities for the Seattle, Wash. area based on an internet search, information obtained from a user's calendar that might indicate where the user might be at a given time, or the like. In one embodiment, a plurality of editors may select activities for a plurality of predefined areas.

At block 506, sponsor paid activities are obtained. Sponsors may pay for activity information to be provided to users. In one embodiment, sponsors may bid on a priority of its activity. The priority may be an order in which activity suggestions may be displayed to a user. For example, a high priority activity (e.g. a highest bid) may be displayed to a user first, followed by a lower priority activity (e.g. a hid that was less than the highest bid). In some embodiments, the sponsors may bid on user demographic information, where only users matching the bid demographic information receive a suggestion for the sponsor activity. Similarly, the sponsors may bid on a demographic and a priority for an activity. In one embodiment, a sponsor who pays more than another sponsor for a specific demographic profile may have a higher priority than the other sponsor, such that the higher priority activity is displayed to a user before the lower priority activity.

At block 508, user published activities are obtained. In some embodiments, users may publish information about their personal activities. In one embodiment, a user published activity may contain certain criteria for when the activity gets suggested to a user. A non-limiting and non-exhaustive example of such criteria may include a location of the user, relationship of the user compared to the user who published the activity, user interests, user profile information, or the like.

At block 510, mined activities are obtained. Mined activities may include any activity that can be obtained from user actions for a first user. The following are non-limiting and non-exhaustive examples of user actions that may be used to obtain mined activities: a user's online search behavior; a user's behavior on social networking sites; a social stream of a user; a user's click through behavior on web pages; a user's groups subscriptions and participation in online discussions; a user's behavior on review web sites, such as page views, comments or the like; a user's behavior on aggregated ranking sites, such as Buzz.yahoo.com; a user's behavior on query based sites, such as Answers.yahoo.com; social bookmarking; commonly visited sites by a user; a user's shopping behavior; a user's comments on a blog or news item; a user's messenger and/or email behavior, including emails in the user's inbox; a user's behavior on career and/or job web sites; a user's time and amount of active interne browsing; randomness of a user's browsing, such as an amount of deviation from a normal browsing behavior of the user; or the like. In some embodiments, user actions may be tracked, such as by Yahoo Mail applications, Facebook applications, and other monitor and/or tracking applications. Based on the user actions, activities can be determined and obtained by the system. In one embodiment, user actions may directly provide activities, such as through search behavior. In another embodiment, user actions may indirectly provide activities. For example, a user may purchase a new backpack online, which may provide an indirect activity of hiking.

Continuing to block 512, user attributes are obtained. In some embodiments, user attributes may include user actions, demographic information, user profile information, or the like. In one embodiment, user actions may be obtained from a user through client device, such as client device 200 of FIG. 2. In another embodiment, demographic information may be obtained about a user and/or a client device, such as client device 200 of FIG. 2, used by a user. Demographic information may include a user's location, age, gender, or the like. In some embodiments user attributes may be obtained from other users, such as social network friends of a first user.

Proceeding next to block 514, a plurality of activities is identified based on the obtained user attributes and the possible activities. In some embodiments, the user attributes may be used to identify those activities which the user may have an implicit interest. Thus, the plurality of activities may be suggestions for activities that the user may have an interest in participating. In some embodiments, the plurality of activities may be identified based on user attributes of other users, such as friends of a first user.

In some embodiments, the user attributes may be used to prioritize the identified plurality of activities. In one embodiment, the priority of the plurality of activities may be employed to sort and/or order the plurality of activities for display. For example, in one embodiment, a distance between the user and an activity may be used to prioritize the plurality of activities. In one embodiment, the user's demographic information may be used to identify activities from editor selected activities. For example, if the user is located in Seattle, Wash., then editor selected activities for Seattle, Wash. may be identified. In another embodiment, sponsor paid activities may be identified based on the user's demographic information.

In some embodiments, block 514 may further identify implicit interest of another user for at least one activity. This embodiment may be employed when identifying for at least one activity in the plurality of activities, at least one other user having an interest in the at least one activity, such as for block 404 of FIG. 4. In one embodiment, a comparison may be made between the plurality of activities for another user and a plurality of activities for a first user. Thus, in one embodiment, if at least one activity is in both the plurality of activities for another user and in the plurality of activities for a first user, then the other user may have an implied interest in the at least one activity. As a result, the other user may be identified as having an implicit interest in at least one of the activities in the plurality of activities for the first user. In some embodiments, information about the other user having an implicit interest in at least one activity may be selectively displayed with a suggestion for the at least one activity, which is described below in conjunction with block 604 of FIG. 6.

Process 500 then proceeds to option block 516, where an input that indicates an explicit interest for an activity from the other user is received. In some embodiments, such as when process 500 is implemented for a first user, option block 516 may not be included in process 500. In other embodiments, the other user may provide the input by actively selecting an icon to indicate an explicit interest in at least one activity. In some embodiments, information about the other user indicating an explicit interest in at least one activity may be selectively displayed with a suggestion for the at least one activity, which is described below in conjunction with block 608 of FIG. 6.

Process 500 next proceeds to block 518, where suggestions for the identified plurality of activities are displayed for a first user. The suggestions may be displayed to a client device, such as client device 200 of FIG. 2. Block 518 may not be employed for identifying the at least one other user for block 404 of FIG. 4. In one embodiment, a single suggestion may be displayed at a time to the first user. Thus, the first user may be enabled to click through each suggestion one at a time. In one embodiment, the first user may be enabled to click to a next suggestion and/or a previous suggestion. In another embodiment, a first set of suggestions may be displayed to the first user. In one embodiment, the first set of suggestions may include 5 suggestions. However, the invention is not so limited and any suitable number of suggestions may be displayed at a time to the first user. In another embodiment, the first user may be enabled to click to another set of suggestions. In some embodiments, suggestions for the plurality of activities may be displayed for the first user before another user indicates an explicit interest or has an implicit interest in any of the plurality of activities. FIGS. 9A-9E described below show non-limiting and non-exhaustive examples of use cases illustrating an interface for displaying the suggestions for a plurality of activities to a user. In some embodiments, the first user may be enabled to store suggestions for access at a later time. After block 518, process 500 returns to a calling process to perform other actions.

FIG. 6 illustrates a logical flow diagram generally showing one embodiment of a process for selectively displaying at least one other user that is interested in at least one activity. Process 600 of FIG. 6 begins, after a start block, at decision block 602, where a determination is made whether to selectively display other users having an implicit interest in at least one activity. If other users have an implicit interest are selectively displayed, then process 600 proceeds to block 604; otherwise process 600 proceeds to decision block 608. In some embodiments the display to a first user may be selectable by the first user.

At block 604, information about at least one other user having an implicit interest in at least one activity is selectively displayed with the respective at least one activity. Information about other users can include a user's name, email address, alias, avatar, photo, icon, or the like. In some embodiments, the information that is selectively displayed may be to a client device, such as client device 200 of FIG. 2, for a first user. In some embodiments, the information may include text, color, and/or other graphical indications of the at least one other users interest in the at least one activity. Since the first user can view at least one other user that has an implicit in at least one activity, the first user may be nudged to indicate an explicit interest in one or more of the at least one activity.

Process 600 next proceeds to option block 606, where the selective display is modified for at least one user having an implicit interest to signify that the at least one user has indicated an explicit interest. In one embodiment, option block 606 may not be performed. In another embodiment, option block 606 may be perform after selectively displaying information about at least one other user having an implicit interest in at least one activity. In one embodiment, the at least one other user having an implicit interest may actively select an icon to indicate an explicit interest for an activity. The modification of the selective display may create a progressive nudge. A progressive nudge occurs when a plurality of users actively indicate an explicit interest for an activity based on another user actively indicating an explicit interest in the same activity. Thus, when one user indicates an explicit interest for an activity, the other users may be nudged to also be interested in the activity. The more users that indicate an explicit interest for an activity, the more a user having an implicit usage is nudged to activity indicate an explicit interest. Progressive nudging increases interest for an activity among a plurality of users.

If other users having an implicit interest are not selectively displayed at decision block 602, then process 600 flows to decision block 608, where information about at least one other user indicating an explicit interest in at least one activity is selectively displayed with the respective at least one activity. In some embodiments, the information that is selectively displayed may be to a client device, such as client device 200 of FIG. 2, for a first user. Additionally, the information about other users can include a user's name, email address, alias, avatar, photo, icon, or the like. Information about the at least one other user may be selectively displayed when the at least one user expressly indicates an explicit interest for an activity, such as by clicking on a button. Therefore, the display may not include information about other users until another user clicks on a button to indicate an explicit interest for an activity. The information that is selectively displayed may include a label identifying the at least one other user. In some embodiments, the information may include text, color, and/or other graphical indications of the at least one other users interest in the at least one activity. Thus, the information that is displayed may nudge the first user to be interested in or participate in the at least one activity. FIGS. 9A-9E described below show non-limiting and non-exhaustive examples of use cases illustrating an interface for displaying the identified at least one other user with at least one activity.

From block 608 and option block 606, process 600 returns to a calling process to perform other actions.

FIG. 7 illustrates a logical flow diagram generally showing one embodiment of a process for automatically organizing an event for an activity for a first user and at least one other user indicating an explicit interest. Process 700 of FIG. 7 begins, after a start block, at decision block 702, where a determination is made whether a minimum number of other users have indicated an explicit interest for an activity. In some embodiments, the explicit interest of the other users may be based on a level of interest. In one embodiment, a user may be able to indicate, such as by clicking on an icon, an interest level for an activity. Thus, the determination made at block 702 may be based on a minimum number of other users indicating an explicit interest that satisfies or is above a threshold for an activity in the plurality of activities. In some embodiments, an event may be automatically organized for the first user and not for the other users indicating an explicit interest. In one embodiment, automatically organizing an event for the first user may further include receiving an indication from the first user of an explicit interest in the activity. If a minimum number of other users have indicated an explicit interest above a threshold, then process 700 proceeds to block 704; otherwise, process 700 returns to a calling process to perform other actions. In some embodiments, explicit interest may include a plurality of levels, where each level has a weight, such as high, medium, and low. In one embodiment, the minimum number of other users above a threshold indicating an explicit interest may have a weight above a threshold. For example, other users having an explicit interest of “high” may be included in the minimum number of other users above a threshold, but other users having an explicit interest of “medium” may not.

At block 704, a time and location for an event are determined. In one embodiment, the time may include a date, a start time for the event, end time for the event, duration, or the like. In some embodiments, the time and location for the event may be provided by the activity suggestions. For example, a sponsor paid activity may include a time and location for an activity, such as a concert. In other embodiments, the time and location for the event may be determined based on first user attributes and/or other user attributes and/or calendar entries. For example, user attributes may include online searches for boating clubs in Chicago, Ill. and that the first user and the other users are free this weekend. As a result, the system may automatically organize a boating event for this weekend in Chicago.

Process 700 continues at block 706, where other resources may be determined and/or automatically organized for the event. In one embodiment, the other resources may be optional and/or selectable by a user. Other resources may include, but are not limited to, venue reservations for the event, such as a restaurant reservation; equipment rentals, such as a boat rental; buying tickets for the event; or the like. These examples of resources should not be construed as limiting; rather it is envisaged that other event resources may be automatically determined and/or organized.

Process 700 next proceeds to block 708, where a communication to a first user and at least one other user is automatically initiated. In one embodiment, a communication may be automatically initiated to other users who are interested in the activity. In another embodiment, a communication may be automatically initiated to users indicating and explicit interest and/or users having an implied interest. In one embodiment, the automatically initiated communication may be performed independent of an action by a user, such as clicking on an icon. In some embodiments, the communication may be an email, instant message, Facebook post, calendar updates, or the like, and/or any combination thereof.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

### Illustrative Examples of User Interfaces

Examples of a user interface for a client device, such as client device 200 of FIG. 2, to allow a current user (which may also be referred to as a first user) to initiate activity suggestions will be described with respect to FIG. 8A and FIG. 8B. While FIGS. 8A and 8B illustrate two embodiments of example user interfaces for a client device to allow a current user to initiate activity suggestions, the invention is not so limited. Rather, these examples are intended merely to illustrate how an a user interface for initiating activity suggestions may be employed, and should not be considered as exhaustive or limiting examples. Additionally, the following examples are primarily described with reference to buttons or links, which is not to be construed as limiting or exhaustive; rather, other user input interfaces known to those skilled in the art may be employed without departing from the scope or spirit of the invention.

As illustrated, web page 800A may include search bar 802, category links 804, current user 806, logout 808, and activity suggestor 810. Not all components of web page 800A may be needed to employ the present invention. Similarly, web page 800A may contain additional components that are not shown. Again, web page 800A is merely an example, and other components, combination of components, or the like may be implemented without departing from the scope or spirit of the invention.

Search bar 802 may allow a user to search the internet for content. Category links 804 may further refine a search to a specific category, such as images. Category links 804 may also be links to other web site features, such as email or the like. Current user 806 may include text and/or other graphics to indicate the user who is currently logged in to the web site. Logout 808 may be a link to allow the currently logged in user to log out of the web site. In some embodiments, a user may not be logged in to initiate activity suggestor 810. In other embodiments, a user may be logged into a social network. Activity suggestor 810 may be a link to employ a process to allow the user to receive activity suggestions, such as process 400 of FIG. 4 and more specifically process 500 of FIG. 5. In some embodiments, activity suggestor 810 may link to a different web page and/or open a new web browser window. The different web page may be an interface to display suggested activities with other users who are interested in those activities, such as the interface examples depicted in conjunction with FIGS. 9A-9E.

FIG. 8B shows one example of a user interface for a client device, such as client device 200 of FIG. 2, to allow a current user to initiate activity suggestions. As illustrated, web browser 800B may include search bar 802, back button 912, forward button 814, refresh button 816, Uniform Resource identifier (URI) input box 818, and toolbar 820. Not all components of web browser 800B may be needed to employ the present invention. Similarly, web browser 800B may contain additional components that are not shown. Again, web browser 800B is merely and example, and other components, combination of components, or the like may be implemented without departing from the scope or spirit of the invention.

Back button 912 may allow a user to visit a previously visited web page in a sequential order of web sites visited. Similarly, forward button 814 may allow a user to visit a subsequently visited web page after the user uses back button 912. Refresh button 816 may allow a user to reload the currently viewed web page. URI input box 818 may allow a user to input a URI, including a uniform resource locator (URL), to visit a particular web page.

Toolbar 820 may be a personalized web browser add-on toolbar that allows a user to access bookmarks, links to specific web pages, additional browser features and/or functions, or the like. Toolbar 820 may allow a user to log in for access to specific features of the toolbar, such as the user's email inbox. In this non-limiting and non-exhaustive example, toolbar 820 may include game button 822, mail button 924, activity suggestor 810, current user 806, and logout 808. Game button 822 may include a link to a web page that includes a plurality of online games. Mail button 924 may be a link to an email service provider and/or a current user's email inbox. Current user 806 may include text and/or other graphics to indicate the user who is currently logged into toolbar 820. Logout 808 may be a link to allow the currently logged in user to log out of toolbar 820. Activity suggestor 810 may be a link to allow the user to initiate a process to allow the user to receive activity suggestions, such as process 400 of FIG. 4 and more specifically process 500 of FIG. 5. In some embodiments, activity suggestor 810 may link to a different web page and/or open a new web browser window. The different web page may be an interface to display suggested activities with other users who are interested in those activities, such as the interface examples depicted in conjunction with FIGS. 9A-9E.

Examples of a user interface for a client device, such as client device 200 of FIG. 2, to display activity suggestions to a current user (which may also be referred to as a first user) and receive an interest input from the current user will be described with respect to FIGS. 9A-9E. While FIGS. 9A-9E illustrate five embodiments of an example user interface for initiating activity suggestions for a client device, the invention is not so limited. Rather, these examples are intended merely to illustrate how an a user interface for initiating activity suggestions may be employed, and should not be considered as an exhaustive or limiting examples. Additionally, the following examples are primarily described with reference to buttons or links, which is not to be construed as limiting or exhaustive; rather, other user input interfaces known to those skilled in the art may be employed without departing from the scope or spirit of the invention.

As illustrated, example 900A of FIG. 9A may include suggested activities 902, no interest button 908, and yes interested button 910. Suggested activities 902 may include suggestions for a plurality of activities that are displayed for a current and/or first user, which may employ a process such as process 500 of FIG. 5. Suggested activities 902 may be prioritized alphabetically, chronologically, by sponsor bids, location relative to the user, a number of other users who are interest the activities, current user attributes, or the like. In one embodiment, other users may not be selectively displayed until another user indicates an explicit interest in at least one of the suggested activities 902, such as by clicking on a yes interest button 910. Once another user indicates an explicit interest in a suggested activity, then the other user may be selectively displayed (such as shown in one embodiment of FIG. 9B).

No interest button 908 may allow a current user to actively indicate that the current user is not interested in a particular activity. No interest button 908 may be any suitable interactive interface that allows the current user to indicate a lack of interest for an activity. Yes interest button 910 may allow the current user to actively indicate that the current user has an explicit interest in a particular activity. Additionally, yes interest button 910 may be any suitable interactive interface that allows the user to indicate an explicit interest in a particular activity.

FIG. 9B illustrates another example of a user interface for displaying activity suggestions to a current user and receiving an interest input from the current user. In some embodiments, Example 900B of FIG. 9B may be an embodiment of Example 900A of FIG. 9A. For example, Example 900B may display other users 904 to a current user when other users 904 have indicated an explicit interest in at least one of suggested activity 902. In another embodiment, other users 904 may be selectively displayed based other users 904 having an implicit interest in at least one of suggested activities 902. In any event, Example 900B of FIG. 9B may include suggested activities 902, other users 904, no interest button 908, and yes interested button 910.

Other users 904 may include information about other users having an interest in one of suggested activities 902. Other users 904 may be selectively displayed with the activity for which they are interested. In one embodiment, other users 904 may include those users that have an implicit interest in at least one activity of suggested activities 902. In other embodiments, other users 904 may include those users that indicate an explicit interest in at least one activity of suggested activities 902.

In some embodiments, the information displayed to show other users 904 may indicate an explicit interest or an implicit interest of other users 904. In one embodiment, text may be used to signify a user having an implicit interest. As shown, “Bob” may have an implicit interest in “Happy Hour at Phil's Pizza,” which is signified by the text “may be interested.” In another embodiment, the text may be modified if at least one of other users 904 indicates an explicit interest. For example, if “Bob” indicates an explicit interest, then the accompanying text may be modified (not shown) to state “VERY interested.” in yet other embodiments, a color of the information about other users 904 may change when other users 904 indicate an explicit interest for an activity. In one embodiment, information about other users 904 may not be displayed until other users 904 indicate and explicit interest. It is envisaged that a change in a user's interest may be signified by suitable display modification known to those skilled in the art and should not be limited to only those examples described herein.

FIG. 9C illustrates another example of a user interface for displaying activity suggestions to a current user and receiving an interest input from the current user. In some embodiments, Example 900C of FIG. 9C may be an embodiment of Example 900B of FIG. 9B. For example, Example 900C may display to a current user one activity suggestion at a time, whereas Example 900B may display a plurality of activity suggestions. In any event, Example 900C may include current activity suggestion 912, other users 904, previous suggestion 914, interested button 916, not interested button 918, and next suggestion 920.

Current activity suggestion 912 may be one of suggested activities 902 of FIG. 9B. Previous suggestion 914 may allow a current user to view a previously viewed activity suggestion. Next suggestion 920 may allow a current user to view another activity suggestion. Previous suggestion 914 and next suggestion 920 may allow a current user to incrementally step through a plurality of activity suggestions. In some embodiments, next suggestion 920 may display an activity suggestion that has a lower priority than current activity suggestion 912.

Interested button 916 may be an embodiment of yes interest button 910 of FIG. 9B, such that a current user may indicate an explicit interest in current activity suggestion 912. Not interested button 918 may be an embodiment of no interest button 908 of FIG. 9B, such that the current user may indicate an explicit lack of interest in current activity suggestion 912. Similar to example 900B, different information about other users 904 may be displayed in example 900C depending on other users 904 indicating an explicit interest or having an implicit interest in current activity suggestion 912

FIG. 9D illustrates another example of a user interface for displaying activity suggestions to a current user and receiving an interest input from the current user. In some embodiments, Example 900D of FIG. 9D may be an embodiment of Example 900C of FIG. 9C. For example, Example 900D may display to a current user a level of interest for each other user 904 having indicated an explicit interest in current suggested activity 912, whereas Example 900C may display only those other users who have indicated an explicit interest, but not a level of interest. In any event, Example 900D may include current activity suggestion 912, other users 904, previous suggestion 914, next suggestion 920, other user interested level 922, comments 924, current user comments 925, and select user interest level 926.

Other user interest level 922 may indicate a level of interest of other users 904 for current activity suggestion 912. In one embodiment, other user interest level 922 may indicate explicit interest levels of other users 904. For example, a user of other users 904 may indicate a “high” explicit interest in current activity suggestion 912 compared to a “low” explicit interest. As a result, a user with a “high” interest level may be more interested in current activity suggestion 912 than another user with a “low” interest level.

Select user interest level 926, may allow a current user to indicate an explicit interest level in current activity suggestion 912. In one embodiment, each level may have a different weight. Thus, in some embodiments, an event may be automatically organized based on a minimum number of other users above a threshold indicating an explicit interest with weight above a threshold. For example an event may be automatically organized when two other users indicate an explicit interest with a weight of “high.” In this example, other users having an explicit interest of “medium” may not be included to determine when to automatically organize an event. In one embodiment, select user interest level 926 may include a plurality of buttons, where each button indicates a different level of explicit interest. In another embodiment, select user interest level 926 may include a numerical ranking interface (not shown), which may allow the current user to input a number to indicate an explicit interest level. For example, the current user may input a “5” to indicate more interest for an activity than an input of “2.” Thus, an event may be automatically organized based on other users indicating an explicit interest of “5.”

In some embodiments, comments 924 may be an optional component, which may allow other users 904 to provide comments about current activity suggestion 912. Similarly, current user comments 925 may allow a current user to submit comments, which may be displayed to other users, such as other users 904.

FIG. 9E illustrates another example of a user interface for displaying activity suggestions to a current user and receiving an interest input from the current user. In some embodiments, Example 900E of FIG. 9E may be an embodiment of Example 900B of FIG. 9B. Example 900E may include suggested activities 902, other users 904, select user interest level 926, input bubbles 928, and set selected user interest level 930. Other users 904 may also display information about other users that have indicated an explicit interest, including in one embodiment, an explicit interest level.

Select user interest level 926 may include a plurality of input bubbles 928, where each input bubble 928 may be selected to indicate a current user's explicit interest level in each of suggested activities 902. In one embodiment, the current user may be enabled to select one of input bubble 928 for each of suggested activities 902. Input bubble 928 may be actively selected or deselected by the current user. Similarly, if the current user actively selects an input bubble 928 for one of suggested activities 902 and subsequently actively selects another input bubble 928 the same activity suggestion, then the first input bubble 928 may be automatically deselected. For example, if the current user actively selects “Low” interest level for “Go Boating,” but subsequently actively selects “Medium” interest level for “Go Boating,” then input bubble 928 for the “Low” interest level for the activity “Go Boating” may be automatically deselected. Additionally, based on the actively selected input bubbles 928, the current user's interest levels may be obtained when set selected user interest level 930 is activated. In one embodiment, set selected user interest level 930 may be a button to allow the current user to click on the button, which may store the current user's interest levels and/or display the current user's interest levels to other users 904.

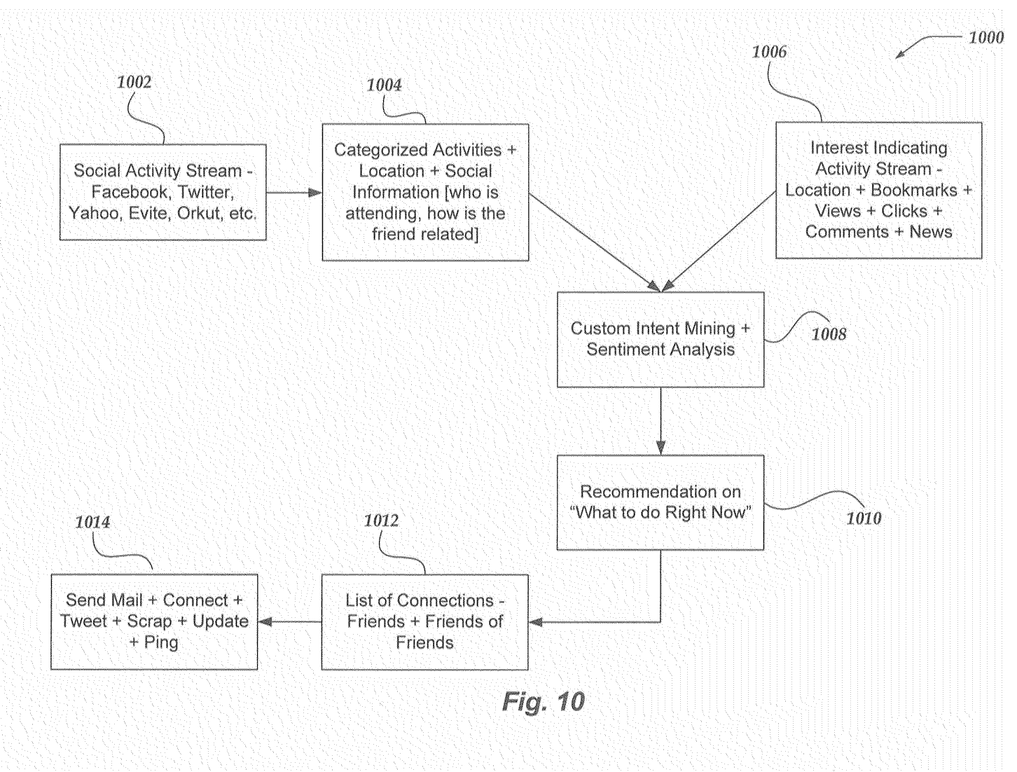

FIG. 10 illustrates a logical flow diagram generally showing one alternative embodiment of an overview process for suggesting activities and automatically organizing an event for interested users.

Example 1000 may begin at block 1002, where a social activity stream is received. In some embodiments, social activity stream may include user actions of other users in a social network. In one embodiment, other users may have a direct relationship with a first user. In other embodiments, social activity stream may indicate other user interests and/or activities. Process 1000 next proceeds to block 1004, where categorized activities, locations, and social information are received. Categorized activities may include sponsor paid activities, editor selected activities, mined activities, or the like. In some embodiments, categorized events may be based on user actions of other users. In some embodiments, location and social information may include other user attributes, such as other user actions and demographic information about other users. In one embodiment, social information may indicate at least one other user having an interest in at least one activity.

At block 1006, an interest indicating an activity stream is received. In some embodiments, the activity stream may include user attributes, including user actions and demographic information about a first user.

Continuing to block 1008, a custom intent mining and sentiment analysis is performed. In some embodiments, the sentiment analysis may be based on the categorized events and/or other user attributes from block 1004 and the interest indicating activity stream from block 1006. In one embodiment, the sentiment analysis may result in a custom intent mining, which may be information about a plurality of activities for a first user.

Process 1000 may then proceed to block 1010, where a recommendation on “What to do right now” may be made. In some embodiments, the recommendation may include suggestions for a plurality of activities. In one embodiment, the recommendation may be displayed to a client device, such as client device 200 of FIG. 2 for a first user. In one embodiment, the recommendation may include displaying one activity suggestion at a time may to the first user. In another embodiment, the recommendation may include displaying a plurality of activity suggestions to the first user.

Proceeding to block 1012, a list of connections may be displayed to the first user. In some embodiments, the list of connections may include other users having an interest in the recommendations from block 1010. In one embodiment, the list of connections may include at least one other user having an interest in one activity, such as when one activity suggestion is displayed to the user. In another embodiment, the list of connections may include a plurality of other users, where each of the other users have an interest for an activity and may be displayed in association with a corresponding activity.

Process 1000 may then proceed to block 1014, where an event is automatically organized for an activity. In one embodiment, automatically organizing an event may include sending an email, posting a tweet, updating a calendar, or the like to the first user and/or other users interested in the activity. In one embodiment, the event may be automatically organized based on a minimum number of other users in the list of connections. After block 1014, process 1000 may return to a calling process to perform other actions.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A method operating on one or more network devices, comprising:
displaying, at a client device, suggestions for a plurality of activities for a first user;
identifying for at least one activity in the plurality of activities, at least one other user having an interest in the at least one activity;
selectively displaying to the first user, information about the identified at least one other user with the respective at least one activity; and
based on a minimum number of the at least one other user above a threshold indicating an explicit interest for an activity in the plurality of activities, automatically organizing an event for the activity for the first user and the at least one other user indicating an explicit interest.

2. The method of claim 1, wherein the event is a physical gathering of the first user and the at least one other user.

3. The method of claim 1, wherein selectively displaying further comprises displaying to the first user, information about, the at least one other user having indicated an explicit interest in the at least one activity.

4. The method of claim 1, wherein selectively displaying further comprises displaying to the first user, information about the at least one other user having an implicit interest in the at least one activity.

5. The method of claim 4, further comprising:
modifying the selective display of at least one user having an implicit interest to signify that the at least one user has indicated an explicit interest.

6. The method of claim 1, wherein an explicit interest is identified by a user actively selecting an icon.

7. The method of claim 1, wherein automatically organizing the event further includes determining a time and location for the event.

8. A network device, comprising:
a transceiver for communicating with at least one client device over a network;
a processor for enabling actions, the actions comprising:
displaying, at one of the at least one client device, suggestions for a plurality of activities for a first user;
determining for at least one activity in the plurality of activities, whether there is identified at least one other user having an interest in the at least one activity;
selectively displaying to the first user, information about the identified at least one other user with the respective at least one activity; and
based on a minimum number of the at least one other user satisfying a threshold indicating an explicit interest for an activity in the plurality of activities, automatically organizing an event for the activity for the first user and selectively for the at least one other user indicating an explicit interest.

9. The network device of claim 8, wherein automatically organizing an event for the first user further comprises receiving an indication from the first user of an explicit interest in the activity.

10. The network device of claim 8, wherein selectively displaying further comprises displaying to the first user, information about the at least one other user having indicated an explicit interest in the at least one activity.

11. The network device of claim 8, wherein selectively displaying further comprises displaying to the first user, information about the at least one other user having an implicit interest in the at least one activity.

12. The network device of claim 11, wherein the processor further enables actions, the actions comprising:
modifying the selective display of at least one user having an implicit interest to signify that the at least one user has indicated an explicit interest.

13. The network device of claim 8, wherein an explicit interest is identified by a user actively selecting an icon.

14. The network device of claim 8, wherein automatically organizing the event further includes determining a time and location for the event.

15. A system for classifying media content, comprising:
at least one network device that manages a communications over a network; and
one or more other network devices that are configured to perform actions, the actions including:
displaying, at a client device, suggestions for a plurality of activities for a first user;
identifying for at least one activity in the plurality of activities, at least one other user having an interest in the at least one activity;
selectively displaying to the first user, information about the identified at least one other user with the respective at least one activity; and
based on a minimum number of the at least one other user above a threshold indicating an explicit interest for an activity in the plurality of activities, automatically organizing an event for the activity for the first user and the at least one other users indicating an explicit interest.

16. The system of claim 15, wherein the event is a physical gathering of the first user and the at least one other user.

17. The system of claim 15, wherein selectively displaying further comprises displaying to the first user, information about the at least one other user having indicated an explicit interest in the at least one activity.

18. The system of claim 15 wherein selectively displaying further comprises displaying to the first user, information about the at least one other user having an implicit interest in the at least one activity.

19. The system of claim 18, wherein the one or more other network devices further enables actions, the actions comprising:
modifying the selective display of at least one user having an implicit interest to signify that the at least one user has indicated an explicit interest.

20. The system of claim 15, wherein an explicit interest is identified by a user actively selecting an icon.
